(19) United States
(12) Patent Application Publication
(10) Pub. No.: US 2011/0145440 A1
(43) Pub. Date: Jun. 16, 2011

(54) Method of distributed computing electronic device and system applying the method

(76) Inventors: Jung-Chang Kuo, Taipei City (TW); Wei-Hao Peng, Taipei City (TW); An-Lun Teng, Taipei City (TW)

(21) Appl. No.: 12/857,623

(22) Filed: Aug. 17, 2010

(30) Foreign Application Priority Data
Dec. 15, 2009 (TW) 098142895

(51) Int. Cl. G06F 15/16

(52) U.S. Cl. 709/246

(57) ABSTRACT

A distributed computing method for a distributed computing system which converts the data of a data-providing end into a format supported by a data-receiving end is disclosed. The distributed computing system comprises a plurality of processing elements, and the method comprises the steps of: recording a first profile of the data-receiving end; determining whether the data-receiving end supports the data of the data-providing end; if not, processing the data of the data-providing end into a format supported by the data-receiving end; and transmitting the processed data to the data-receiving end. The step of processing the data of the data-providing end into a format supported by the data-receiving end further comprises the steps of: partitioning the data into a plurality of sub-data; and assigning the plurality of sub-data to the plurality of processing elements for computing.

### BACKGROUND OF THE INVENTION

1. Field of the Invention

The present invention relates to a distributed computing method and its applications in electronic devices and systems; more particularly, it relates to a distributed computing method and its applications to electronic devices and systems using a plurality of processing elements.

2. Description of the Related Art

With the advancement of technology, people have developed many electronic devices such as computers, PDAs, and mobile phones, which allow users to view video files or text files via the internet. Through the internet transmission functions, these video files or text files can be easily transmitted from one electronic device to another electronic device.

However, when a file is been transmitted from one electronic device to another, problems with opening the file or browsing the file may occur in the other electronic device. The main reason for this problem is that the encoding format for the two electronic devices is different. The problem is more apparent when the two electronic devices are of a different type. For example, a file with a WMV format can be opened on a computer, but it cannot be opened on most mobile phones. As such, codec conversion operations will be required to successfully open the file. However, codec conversion requires a large quantity of calculations and thus requires more system resources. This means that an electronic device that has low calculation capabilities and storage space, such as a mobile phone, will be limited in the transmission of the file types.

Therefore it is necessary to provide a distributed computing method that will solve the problems of the prior technology.

### SUMMARY OF THE INVENTION

The main objective of the present invention is to provide a distributed computing method. By utilizing this method, electronic devices and systems are able to use the distributed computing system to transmit data from a data-providing end to a data-receiving end more efficient and faster. The data that are being transmitted are in a format that is supported by the data-receiving end.

The distributed computing method of the present invention comprises the following steps: recording the first profile of the data-providing end, wherein the first profile comprises a data format that is supported by the data-receiving end; receiving the data provided by the data-providing end; determining whether the data-receiving end supports the data provided by the data-providing end; if the data-receiving end does not support the data format of the data-providing end, then it will process the data from the data-providing end into a format which will be supported by the data-receiving end; and transmits the data to the data-receiving end after the format conversion. The format conversion of the data from the data-providing end into a format that is supported by the data-receiving end comprises the following steps: partitioning the data into a plurality of sub-data; assigning the plurality of sub-data to a plurality of processing elements for computing; converting the data into a format that is supported by the data-receiving end.

In the embodiment of the present invention, the data-providing end comprises a file-providing end, the data-receiving end comprises a file-receiving end, the data comprise a file, and a plurality of sub-data comprises a plurality of sub-file data.

In the embodiment of the present invention, the distributed computing method further comprises the following step: recording the second profile of each processing element. The second profile comprises the system resources of each processing element, and the system resources comprise the files types which can be provided, computing capabilities, transmission capabilities, and memory space. According to the second profile, the next step is partitioning the files into a plurality of sub-files, and according to the second profile, assigning the plurality of sub-files to the plurality of processing elements for computing.

The electronic devices of the present invention comprise a data-providing end, a distributed computing system, and a data-receiving end, which are all electrically coupled and are able to execute the distributed computing method mentioned above.

In the embodiment of the present invention, the data-providing end comprises a file-providing end, the data-receiving end comprises a file-receiving end, the data comprise a file, and a plurality of sub-data comprises sub-file data.

The distributed computing system of the present invention transmits the data from the data-providing end to the data-receiving end, wherein the data being transmitted are in a format that is supported by the data-receiving end. The distributed computing system comprises a receiving module, a database module, a conversion module and a transmission module. The receiving module can receive the data from the data-providing end. The database module records the first profile, wherein the first profile comprises the data format that is supported by the data-receiving end. The conversion module can convert the data from the data-providing end into a format that is supported by the data-receiving end. The conversion module further comprises a plurality of processing elements, a partitioning module, and an assigning module. The partitioning module partitions the data into a plurality of sub-data. The assigning module assigns the plurality of sub-data to the plurality of processing elements for computing. The transmission module transmits the data to the data-receiving end.

When the data-receiving end does not support the data format from the data-providing end, then according to the first profile, the conversion module converts the data into a format that is supported by the data-receiving end. The transmission module can then transmit the data to the data-receiving end.

In the embodiment of the present invention, the data-providing end comprises a file-providing end, the data-receiving end comprises a file-receiving end, the data comprise a file, and a plurality of sub-data comprise a plurality of sub-file data.

In the embodiment of the present invention, the database module further records the second profile, wherein the second profile comprises the system resource of each processing element. The system resource comprises the file types that can be provided, computing capability, transmission capability, memory space, or a real-time loading status. According to the second profile, the partition module partitions the files into a plurality of sub-files, and according to the second profile, the assignment module assigns the plurality of sub-files to the plurality of processing elements for computing.

In the embodiment of the present invention, the conversion module further comprises an analytical module. The analytical module obtains the file conversion data from the first profile, and according to the file conversion data, the partitioning module partitions the files into a plurality of sub-file data; and according to the file converting data, the assignment module assigns the plurality of sub-file data to the plurality of processing elements for computing.

### BRIEF DESCRIPTION OF THE DRAWINGS

FIG. 1 is a block diagram showing the operation environment of the distributed computing system for one embodiment.

FIG. 2 is a block diagram showing the operation environment of the distributed computing system for one embodiment.

FIG. 3 is a functional block diagram of the distributed computing system for the embodiment of the present invention.

FIG. 4 is a block diagram showing the operation environment of the distributed computing system for one embodiment.

FIG. 5 is a block diagram showing the operation environment of the distributed computing system for one embodiment.

FIG. 6 is a flowchart showing an embodiment of the distributed computing method.

FIG. 7 is a flowchart showing an embodiment of the distributed computing method.

FIG. 8 is a flow chart showing the file conversion process.

FIG. 9 is a flowchart showing an embodiment of the distributed computing method.

### DETAILED DESCRIPTIONS OF THE PREFERRED EMBODIMENTS

The advantages and innovative features of the invention will become more apparent from the following descriptions of the preferred embodiments.

The distributed computing system of the present invention transmits the data from the data-providing end to the data-receiving end, wherein the data being transmitted are in a format that is supported by the data-receiving end. If the data-receiving end does not support the data from the data-providing end, then the distributed computing system will convert the data into a format that is supported by the data-receiving end.

In the embodiment of the present invention, the data format of the data-providing end may be different from the data format that is supported by the data-receiving end. In this situation, the distributed computing system will proceed with the data format conversion on the data of the data-providing end, but the present invention is not limited to this.

For example, the data format from the data-providing end may be supported by the data-receiving end, but require further processing, such as data compression, in order to reduce the data bit stream, as this benefits data transmission or improves data quality (such as video or image clarity). Under these circumstances, the distributed computing system will proceed with processing the data from the data-providing system.

In the embodiment of the present invention, the data-providing end comprises a file-providing end, the data-receiving end comprises a file-receiving end, and the data comprise a file. When the distributed computing system proceeds with processing the data from the data-providing end, it partitions the data into a plurality of sub-data, wherein the plurality of sub-data comprises a plurality of sub-file data. Regarding the method of partitioning the data into a plurality of sub-file data, we will provide a more detailed explanation later on. Please note that the present embodiment uses the distributed computing system to transmit the file from the file-providing end to the file-receiving end, but the data of the present invention are not restricted to the concept of the file. The distributed computing method, electronic device, and distributed computing system can be applied to data of any form.

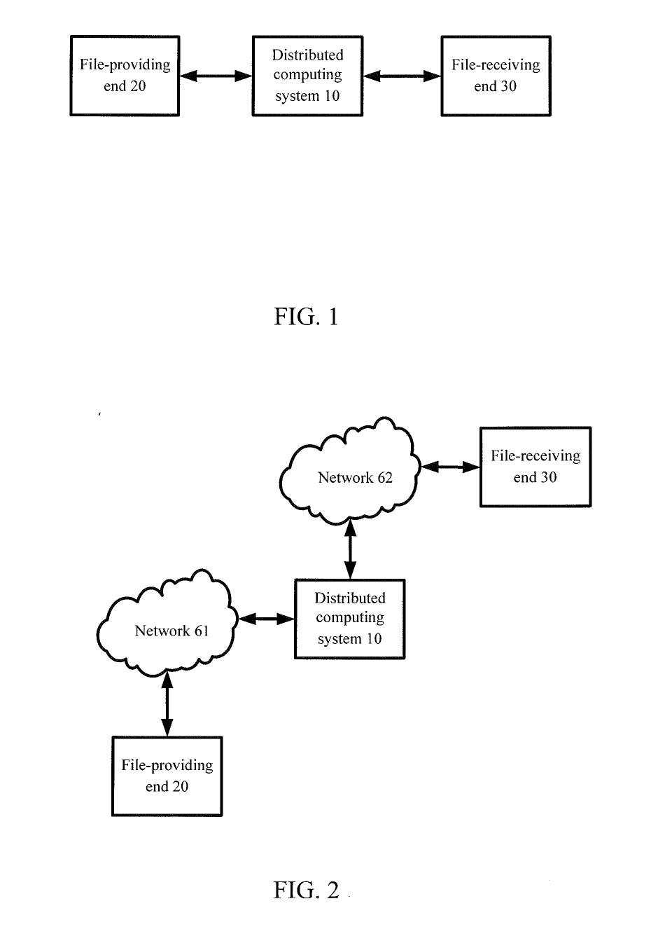

Refer to FIG. 1. FIG. 1 is a block diagram showing the operation environment of the distributed computing system for one embodiment. As shown in FIG. 1, the distributed computing system 10, the file-providing end 20, and the file-receiving end 30 are all electrically coupled. The distributed computing system 10 is used to transmit files from the file-providing end 20 to the file-receiving end 30, wherein the files being transmitted are in a format that is supported by the file-receiving end 30. In the embodiment of the present invention, these files provided by the file-providing end 20 comprise image files, audio files, video files, or text files, but the present invention is not limited to this.

As shown in FIG. 2, the distributed computing system 10 is connected to the file-providing end 20 via the network 61, and connected to the file-receiving end 30 via the network 62. The distributed computing system 10 can receive these files from the file-providing end 20 via the network 61, and transmit these files to the file-receiving end 30 via the network 62, wherein the format of the file is supported by the file-receiving end 30.

The network 61 and the network 62 can be an online network or a wireless network; the network 61 and the network 62 can be the internet, a General Packet Radio Service (GPRS), a Third Generation (3G) mobile communication system, a Wireless Fidelity (Wi-Fi) network, or a Worldwide Interoperability for Microwave Access (WiMAX) network, but the present invention in not limited to these networks. Furthermore, the network 61 and the network 62 can be of the same type of network, or they can be of different types of network. For example, the network 61 can be an online internet, and the network 62 can be a wireless 3G mobile communication network.

Furthermore, in the embodiment of the present invention, the data from the data-providing end 20 comprise resources that exist on the interne (such as YouTube, eMule, eDonky, Kuro, ezPeer, BitTorrent, which are Peer-to-Peer transmission websites), but the present invention is not limited to this. For example, the data can be stored in the data-providing end 20.

In the embodiment of the present invention, the file-providing end 20 can be a software program, hardware, firmware, or a combination thereof. The file-providing end 20 can be assigned to a computer, a network server, a mobile phone, a PDA game console, or a set-top box, but the present invention is not limited to this.

In the embodiment of the present invention, the file-receiving end 30 can be a software program, hardware, firmware or a combination, and the file-receiving end 30 can be assigned to a computer, a network server, a mobile phone, a PDA, a game console, or a set-top box, but the present invention is not limited to this.

Furthermore in the embodiment of the present invention, the distributed computing system 10 can be a software program, hardware, firmware, or a combination thereof, and the distributed computing system 10 can be assigned to one or multiple computers, a network server, a mobile phone, a PDA, a game console, or a set-top box, but the present invention is not limited to this.

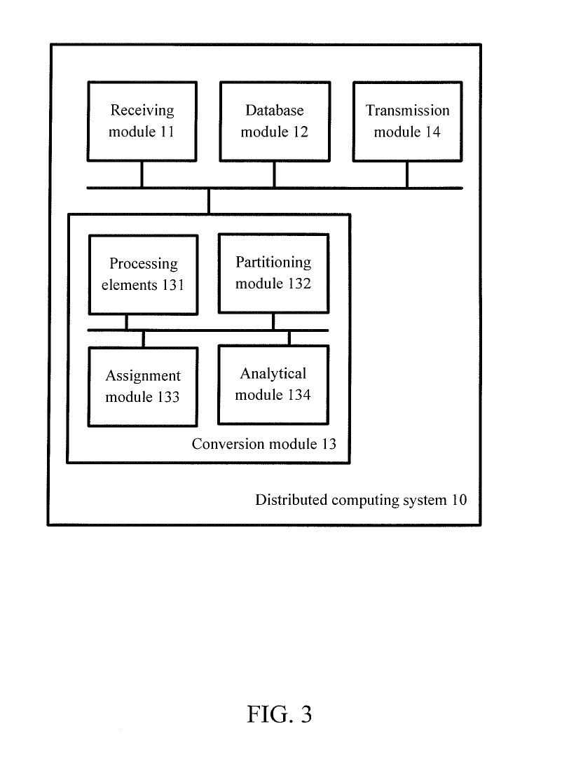

Please refer to FIG. 3, which is the functional block diagram of the distributed computing system 10 for the embodiment of the present invention.

As shown in FIG. 3 of the embodiment of the present invention, the distributed computing system 10 comprises a receiving module 11, a database module 12, a conversion module 13, and a transmission module 14.

The receiving module 11 can receive these files provided by the file-providing end 20. The database module 12 records the first profile and the first profile comprises a file format that is supported by the file-receiving end 30, but the present invention is not limited to this. In the embodiment of the present invention, the receiving module 11 and the database module 12 are configured as a hardware device, a firmware or an electric circuit, but the present invention is not limited to this.

The converting module 13 can convert files from the file-providing end 20 into a format that is supported by the file-receiving end 30, wherein the converting module 13 further comprises a plurality of a processing elements 131, a partitioning module 132, an assignment module 133, and an analytical module 134. In the embodiment of the present invention, the analytical module 134 obtains the file converting data from the first profile; when the partitioning module 132 partitions the files according to the file converting data, the partitioning module 132 partitions the files into a plurality of sub-file data with the same or different properties. Please note that the partitioning module 132 is not limited to the file converting data for partitioning the files into a plurality of sub-file data with the same or different characteristics. In the embodiment of the present invention, the converting module 13 and the partitioning module 132 are configured as a hardware device, a firmware or an electric circuit, but the present invention is not limited to this.

In the embodiment of the present invention, if the distributed computing system 10 is assigned to a computer, a network server, a mobile phone, a PDA, game console, or a set-top box, then the processing element 131 can comprise a central processing unit (CPU), a graphic processing unit (GPU), an arithmetic logic unit (ALU), a digital signal processor (DSP), or hardware accelerator circuits, but the present invention is not limited to this. For example, if the distributed computing system 10 is assigned to multiple computers, a network server, a mobile phone, a PDA, a game console, or a set-top box, then the processing element 131 comprises computers, a network server, a mobile phone, a PDA, a game console, or a set-top box.

In the embodiment of the present invention, the database module 12 further records the second profile. The second profile comprises the system resources for each processing element 131, wherein the system resources comprise the files types that can be provided, computing capability, transmission capability, memory space or a real-time loading status, but the present invention is not limited to this. In the embodiment of the present invention, according to the second profile, the partitioning module 132 partitions the files into a plurality of sub-file data with the same or different properties. Then, according to the second profile, the assignment module 133 assigns the plurality of sub-file data to the plurality of the processing elements 131 for computing. Please note that in the distributed computing system 10 of the present invention, according to the file conversion data or the second profile, the partitioning module 132 partitions the files into a plurality of sub-file data with the same or different properties; however, the present invention is not limited to this.

In the embodiment of the present invention, the assignment module 133 allows the system resources of each processing element 131 (such as files, computing capabilities, memory space) to be shared mutually. In the embodiment of the present invention, apart from the assignment module 133 being assigned to a hardware device, firmware, or other such combination, it can also be assigned to a circuit loop or other suitable devices. When the partitioning module 132 partitions the files into a plurality of sub-file data with the same or different characteristics, the assignment module 133 then assigns the file converting operations to each of the processing elements 131 for computing and assembly. This improves efficiency when a large quantity of file conversion operations is required. In the embodiment of the present invention, the assignment module 133 can assign a plurality of sub-file data according to the system resources (or computing capabilities) of each processing element 131. For example, the processing element 131 with a high computing capability can process more or complicated sub-file data. Another example is a processing element 131 that has a unique computing capability to process sub-file data with unique characteristics.

In the embodiment of the present invention, the transmission module 14 is used to transmit the files to the file-receiving end 30 after the file conversion, but the present invention is not limited to this.

As shown in FIG. 2 and FIG. 3 in the embodiment of the present invention, when the distributed computing system 10 transmits the files to the file-receiving end 30 via the network 62, in addition to transmitting the actual file to the file-receiving end 30 for downloading, it can also transmit stream data to the file-receiving end 30 for browsing. For example, according to the first profile recorded by the database module 12, the transmission module 14 can determine if the file-receiving end 30 supports RTP (Real-time Transport Protocol); if it does, then the transmission module 14 can choose to transmit stream data to the file-receiving end 30, and proceed with transmission ahead of schedule.

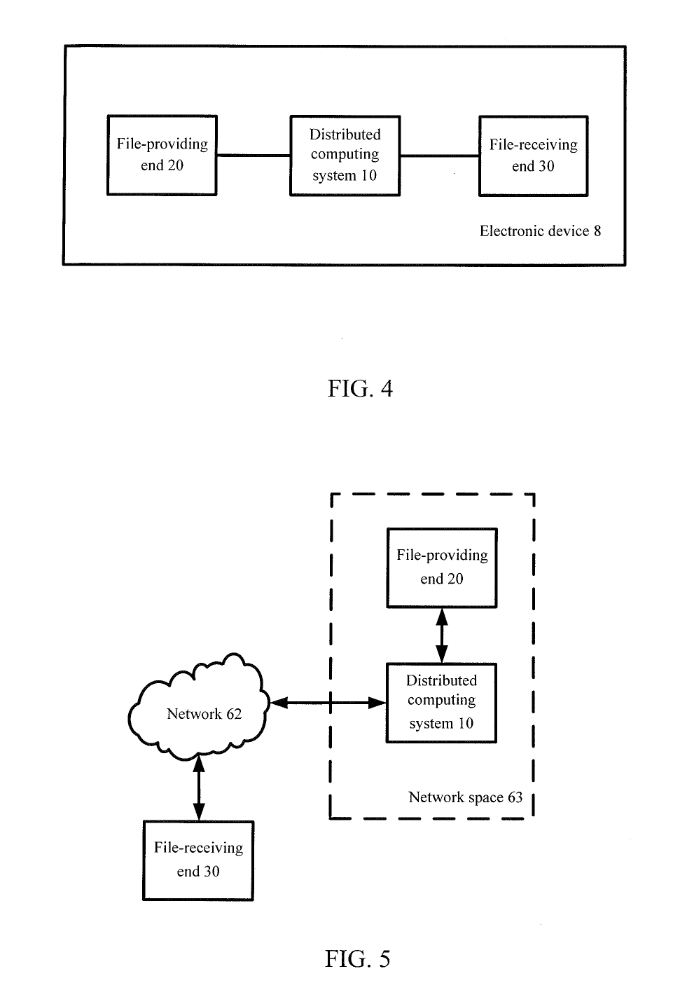

Please refer to FIG. 4, which is the function block diagram for the electronic device of the present invention.

As shown in FIG. 4 of the embodiment, the present invention provides a type of electronic device 8, which comprises the file-providing end 20, the distributed computing system 10, and the file-receiving end 30, wherein all three are electrically coupled; the distributed computing system 10 will convert the file from the file-providing end 20 into a format that is supported by the file-receiving end 30, and transmit the file from the file-providing end 20 to the file-receiving end 30. All of these processes are accomplished in the electronic device 8. In the embodiment of the present invention, the electronic device 8 comprises a computer, a network server, a mobile phone, a PDA, a game console, or a set-top box, but the present invention is not limited to this.

Furthermore, as shown in FIG. 5 of the embodiment, the distributed computing system 10 and the file-providing end 20 can be both assigned to the computer, the network server, the mobile phone, the PDA, the game console, or the set-top box of a same network space 63, and each of the electronic devices in the same network space 63 can share their system resources mutually (such as files, computing capability, transmission capability, memory space, or the real-time loading status). Apart from the distributed computing system 10 being electrically coupled to the file-providing end 20 through a network connection, it can also be electrically coupled via a bus, an online connection, an electrical circuit, or other methods.

The distributed computing system of the present invention will be described with detailed explanations of the steps of the distributed computing method. Please note that as long as the objective of the present invention can be achieved, the method of the present invention is not limited to being used in the distributed computing system.

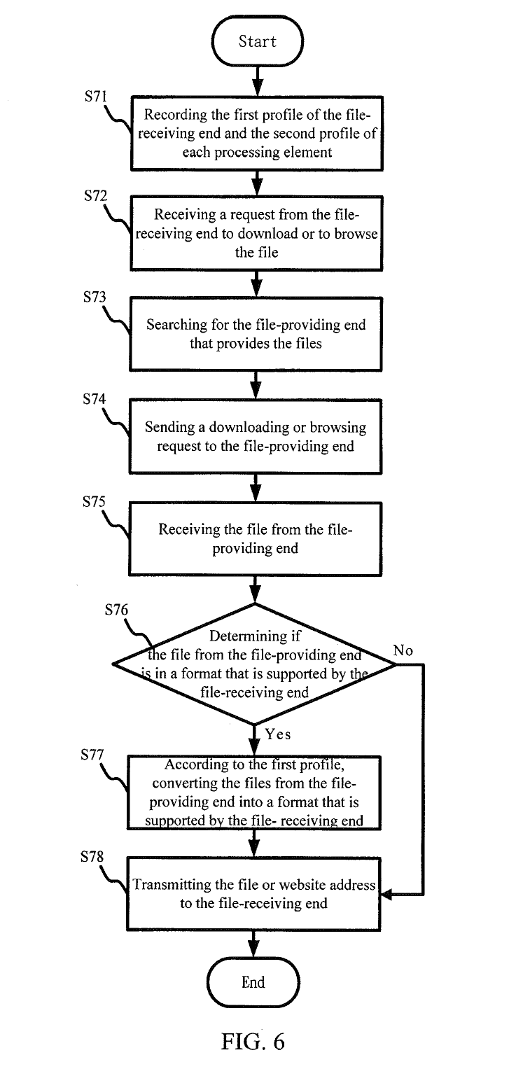

Refer to FIG. 6 for the flowchart of the distributed computing method. As shown in FIG. 6, the present invention proceeds first with step S71: recording the first profile of the file-receiving end and the second profile of each processing element.

In the embodiment of the present invention, the first profile comprises the file format that is supported by the file-receiving end, the second profile comprises the system resource of each processing element, and the system resources comprise the file types that can be provided, computing capabilities, transmission capabilities, or memory space, but the present invention is not limited to this. For example, the first profile can comprise the screen size, the CPU efficiency, and the size of the memory space of the file-receiving end 30, from which can be determined the most suitable file format for the file-receiving end 30 to receive.

Next, the present invention proceeds with step S72: receiving a request from the file-receiving end to download or to browse the file.

In step S72, the present invention can receive a request from the file-receiving end 30 to download or to browse the file. In the embodiment of the present invention, the file-receiving end 30 is a user end, and the file-providing end 20 is a service end, but the present invention is not limited to this. The user end can request to download or to browse the files provided by the service end via a network, but the present invention is not limited to this.

Next, proceed with step S73: searching for the file-providing end that provides the files.

In the embodiment of the present invention, the file-providing end 20 may be a computer, a network server, a mobile phone, a PDA, a game console, or a set-top box, which is assigned to the same network space. Therefore in step S73, according to the file request from the file-receiving end 30, the present invention can find the file-providing end 20 that provides the file.

After finding the file-providing end, the present invention proceeds with step S74: sending a downloading or browsing request to the file-providing end.

Next, when the file-providing end responds to step S74, the present invention proceeds with step S75: receiving the file from the file-providing end.

Next is step S76: determining if the file from the file-providing end is in a format that is supported by the file-receiving end.

In step S76, with the format of the file that is supported by the file-receiving end 30 already recorded, the present invention can determine if the files from the file-providing end 20 are supported by the file-receiving end 30.

If the file-receiving end 30 does not support the files from the file-providing end 20, then the present invention proceeds with step S77: according to the first profile, converting the files from the file-providing end into a format that is supported by the file-receiving end.

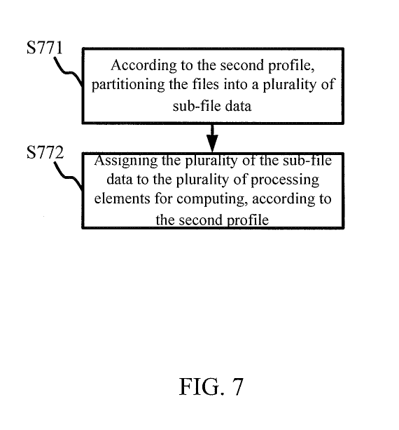

As shown in FIG. 7 of the embodiment of the present invention, step S77 further comprises step S771 and step S772.

Step S771: according to the second profile, partitioning the files into a plurality of sub-file data.

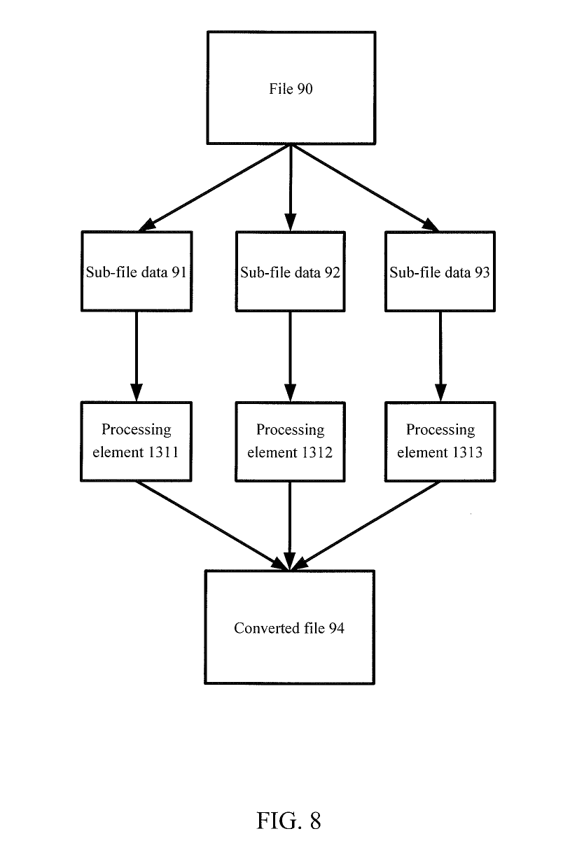

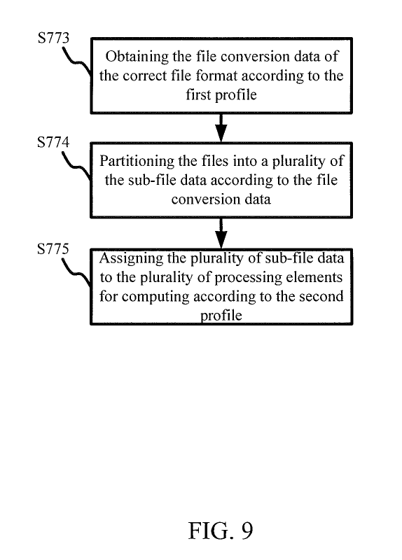

As shown in FIG. 8 of the embodiment of the present invention, according to the system resources of each processing element 131 of the second profile, partitioning module 132 partitions file 90 into a plurality of sub-file data 91, 92, 93 with the same or different properties.

In the embodiment of the present invention, the processing element 131 comprises a CPU 1311, a GPU 1312 and a hardware accelerator circuit 1313. Through the partitioning module 132, most of the processing data from the file 90 forms sub-file data 91, whereas image and graphic related processing data form the sub-file data 92, and the hardware accelerator circuit 1313 related the processing data form the sub-file data 93, but the present invention is not limited to this arrangement.

Next is step S772: assigning the plurality of the sub-file data to the plurality of processing elements for computing, according to the second profile.

As shown in FIG. 8 of the embodiment of the present invention, the assignment module 133 assigns each sub-file data 91, 92, 93 to each processing element 1311, 1312, 1313 for computing according to the second profile. Next, after the computing of each processing element 1311, 1312, 1313, the sub-file data 91, 92, 93 are combined together to form the converted file 94, but the present invention is not only limited to this.

As shown in FIG. 9 of the embodiment of the present invention, step S77 further comprises step S773 to step S775.

Step S773: obtaining the file conversion data of the correct file format according to the first profile.

Next is step S774: partitioning the files into a plurality of the sub-file data according to the file conversion data.

Refer to FIG. 8. As an example, the conversion module 13 converts a file with WMV format from the file-providing end 20 into a compressed file with a RAR format. The analytical module 134 determines that this conversion is suitable for partitioning the file into a plurality of sub-file data with the same properties, and according to the file conversion data during the partitioning of the file, the partitioning module 132 partitions file 90 into a plurality of the sub-file data 91, 92, 93 with the same properties, but the file format of the present invention is not limited to this.

In another example, the conversion module 13 converts a file with an AVI format from the file-providing end 20 into a compressed file with a 3GP format. Because this conversion process involves different tasks with different properties, such as image, audio, and different encoders, the analytical module 134 determines that this conversion is suitable for partitioning the file 90 into a plurality of sub-file data 91, 92, 93 with different properties. According to the file conversion data during the partitioning of file 90, the partitioning module 132 partitions the file 90 into a plurality of sub-file data 91, 92, 93 with different characteristics, but the file format of the present invention is not limited to this arrangement.

Next is step S775: assigning the plurality of sub-file data to the plurality of processing elements for computing according to the second profile.

Note that as shown in FIG. 8 in the embodiment of the present invention, if each of the processing elements 1311, 1312, 1313 possesses different system resources, then according to the system resources of each processing element of the second profile, the assignment module 133 assigns each sub-file data 91, 92, 93 to each processing element 1311, 1312, 1313 for computing.

In the embodiment of the present invention, if each of the processing elements 1311, 1312, 1313 possesses the same kind of system resources, then the assignment module 133 will assign the sub-file data 91, 92, 93 equally among these processing elements 1311, 1312, 1313 according to the second profile for computing.

According to the file format for conversion and the system resources of the processing element 131, the partitioning module 132 and the assignment module 133 can perform the required partitioning and assignment on the file; this improves efficiency during large file conversion operations.

Last is step S78: transmitting the file or website address to the file-receiving end.

In the embodiment of the present invention, the transmission module 14 is used to transmit files to the file-receiving end 30. Please note that when the distributed computing system is connected to the file-receiving end 30 via the network 62, the transmission module 14 can transmit the internet link to file-receiving end 30 so that the file-receiving end 30 can receive the file through the internet link. Apart from transmitting the actual file, the present invention can also transmit a stream of files for the file-receiving end 30 for browsing. Therefore, even if the file-receiving end 30 has limited memory space (such as a mobile phone), it can still browse through the files. In the embodiment of the present invention, transmission module 14 further comprises a temporary file storage module (not shown in the diagram) to store the stream file temporarily.

If the file-receiving end 30 supports the files from the file-providing end 20, then the present invention will directly proceed with step S78.

Combining the abovementioned points, the present invention eliminates all the problems encountered from prior inventions, and comprises the following advantages:

1. The distributed computing system 10 of the present invention can convert the files into a format that is most suitable for the file-receiving end 30, because the database module 12 records the file format that is supported by the file-receiving end 30.

2. The file conversion efficiency is largely improved because the system resources of each processing element 131 of the distributed computing system 10 can be mutually shared, and the file conversion operation is distributed to each processing element 131.

3. The one of the unique aspect of the present invention is that the file-receiving end 30 does not need to consider the format of the files that are to be downloaded or browsed, because the file conversion operations are not carried out by the file-receiving end 30; the file-receiving end 30 does not use up any system resources, as compared to the technology which proceeds with codec conversion operations.

4. The present invention not only transmits the actual files, but it can also transmit stream data to the file-receiving end 30 for browsing purposes. Therefore, even if the file-receiving end 30 has limited memory space (such as a mobile phone), it can still browse through the files.

Although the present invention has been explained in relation to its preferred embodiment, it is also of vital importance to acknowledge that many other possible modifications and variations can be made without departing from the spirit and scope of the invention as hereinafter claimed.

What is claimed is:

1. A distributed method, which is used to process data from a data-providing end by a distributed computing system; the data is processed into a format that is supported by the data-receiving end and transmits the data to a data-receiving end, wherein the distributed computing system comprises a plurality of processing elements; the distributed computing method comprises:
recording a first profile of the data-receiving end, wherein the first profile comprises a data format that is supported by the data-receiving end;
receiving the data provided by the data-providing end;
determining whether the data format provided by the data-providing end is supported by the data-receiving end;
if the data-receiving end does not support the data format of the data-providing end, then processing the data from the data-providing end according to the first profile so that the format of the data will be supported by the data-receiving end, the process further comprising the following steps:
partitioning the data into a plurality of sub-data;
assigning the plurality of sub-data to a plurality of processing elements for computing so that the data will be in a format that is supported by the data-receiving end; and
transmitting the processed data to the data-receiving end.

2. The distributed computing method as claimed in claim 1, wherein the data-providing end comprises a file-providing end, the data-receiving end comprises a file-receiving end, the data comprises a file, and the plurality of sub-data comprise a plurality of sub-file data.

3. The distributed computing method as claimed in claim 2 further comprising the following steps:
recording the second profile of each plurality of processing elements, wherein the second profile comprises the system resources of each processing element; the system resources include file types which can be provided, computing capability, transmitting capability, memory space, or a real-time loading status;
according to the second profile, partitioning the file into a plurality of sub-file data; and
according to the second profile, assigning the plurality of sub-files to the plurality of processing elements for computing.

4. The distributed computing method as claimed in claim 2, wherein the plurality of processing elements comprises a central processing unit (CPU), a graphic processing unit (GPU), an arithmetic logic unit (ALU), a digital signal processor (DSP), or hardware acceleration circuits.

5. The distributed computing method as claimed in claim 2, wherein the plurality of processing elements comprises a computer, a network server, a mobile phone, a PDA, a game console, or a set-top box.

6. The distributed computing method as claimed in claim 2 further comprises the following steps:
obtaining the file conversion data of the file format to be converted according to the first profile;
partitioning the file into the plurality of sub-file data according to the file conversion data; and
assigning the plurality of sub-file data to the plurality of processing elements for computing according to the second profile.

7. The distributed computing method as claimed in claim 6, wherein during the partitioning of the files, the file-converting data determines whether to partition the files into a plurality of sub-file data with the same properties, or with different properties.

8. The distributed computing method as claimed in claim 2, wherein the method utilizes a network to transmit the files from the file-providing end to the file-receiving end via the distributed computing system; the files transmitted are in a format that is supported by the file-receiving end and the method comprises the following step:
after the conversion, transferring the files to the file-receiving end via the network.

9. The distributed computing method as claimed in claim 8, wherein prior to receipt of the files from the file-providing end, further comprises the following steps:
receiving a request for downloading or browsing the file from the file-receiving end;
searching the file-providing end that provides the files; and
sending the request for downloading or browsing the files to the file-providing end.

10. The distributed computing method as claimed in claim 8, wherein the files that are transmitted to the file-receiving end are stream data.

11. The distributed computing method as claimed in claim 8, wherein the files transmitted to the file-receiving end are transmitted to an internet link; the file-receiving end can receive stream data via the internet link.

12. An electronic device comprising: a file-providing end, a distributed computing system and a file-receiving end, wherein all are electrically coupled; the device is thereby able to perform any of the distributed computing methods as claimed in claim 1.

13. The electronic device as claimed in claim 12, wherein the electronic device comprises a computer, an network server, a mobile phone, a PDA, a game console, or a set-top box (STB).

14. A distributed computing system used to transmit data from a data-providing end to a data-receiving end, and the format of the data transmitted is supported by the data-receiving end, the distributed computing system comprising:
a receiving module, which receives the data provided by the data-providing end;
a database module, which records a first profile, and the first profile comprises a data format that is supported by the data-receiving end;
a conversion module, which converts the data from the data-providing end into the format that is supported by the data-receiving end, wherein the data module further comprises:
a plurality of processing elements;
a partitioning module, which partitions the data into a plurality of sub-data;
a distributing module, which is used to distribute the sub-data to their respective processing elements for computing; and
a transmission module, which transmits the data to the data-receiving end;
wherein each of the receiving module, the database module, the conversion module, the plurality of processing elements, the partitioning module, the distributing module and the transmission module is configured as a hardware device, a firmware or an electric circuit; and
if the data-receiving end does not support the data format of the files provided by the data-providing end, then according to the first profile of the data-receiving end, the conversion module will convert the data into a format which is supported by the data-receiving end, and this enables the transmission module to transmit the data to the data-receiving end.

15. The distributed computing system as claimed in claim 14, wherein the data-providing end comprises a file-providing end, the data-receiving end comprises a file-receiving end, the data comprises a file, and the plurality of sub-data comprises a plurality of sub-file data.

16. The distributed computing system as claimed in claim 15, wherein the database module records a second profile, the second profile comprises the system resources of each processing element, and the system resources comprise the files that can be provided, computing capability, transmission capability, memory space, or a real-time loading status; according to the second profile, the partitioning module partitions the file into a plurality of sub-file data;
according to the second profile, the distributed module distributes the plurality of sub-files to the plurality of processing elements for computing.

17. The distributed computing system as claimed in claim 15, wherein the conversion module further comprises an analytical module; the analytical module obtains the file conversion data from the first profile; according to the file conversion data, the partitioning module partitions the file into a plurality of sub-file data; and according to the file conversion data, the distributing module distributes the plurality of sub-file data to the processing elements for computing.

18. The distributed computing system as claimed in claim 17, wherein during the partitioning of the files, the file conversion data determines whether to partition the files into a plurality of file data with the same or different properties.

19. The distributive system as claimed in claim 15, wherein the processing element comprises a central processing unit (CPU), a graphic processing unit (GPU), an arithmetic logic unit (ALU), a digital signal processor (DSP), or hardware acceleration circuits.

20. The distributed computing system as claimed in claim 15, wherein the processing element comprises a computer, a network server, a mobile phone, a PDA, a game console, or a set-top box.

21. The distributed computing system as claimed in claim 15, wherein the file-receiving end is assigned to a computer, a network server, a mobile phone, a PDA, a game console, or a set-top box.

22. The distributed computing system as claimed in claim 15, wherein via the internet, the distributed computing system transmits the files provided by the file-providing end to the file-receiving end; the format of the file been transmitted is in a format that is supported by the file-receiving end.

23. The distributed computing system as claimed in claim 22, wherein the transmission module transmits a stream data to the file-receiving end, and the transmission module comprises a temporary file storage module, providing the string of files with temporary storage.

24. The distributed computing system as claimed in claim 23, wherein the file conversion system and the file-providing end are allocated in the same network area.
